(19) United States
(12) Patent Application Publication
(10) Pub. No.: US 2026/0365031 A1
(43) Pub. Date: Nov. 19, 2026

(54) Switching Device For A Train

(71) Applicant: HOPPECKE Systemtechnik GmbH, Zwickau (DE)

(72) Inventors: Stefan REINHOLD, Zwickau (DE); Magnus TRAPP, Bad Wünnenberg (DE); Tobias GEHRING, Auerbach (DE)

(21) Appl. No.: 19/674,616

(22) Filed: May 12, 2026

(30) Foreign Application Priority Data
May 16, 2025 (EP) 25177045.9

(51) Int. Cl. B60L 3/04; B60L 3/00

(52) U.S. Cl. CPC B60L 3/04; B60L 3/0046; B60L 2200/26

(57) ABSTRACT

A switching device in a current path between a train’s battery module and an on-board power supply includes a battery module-side power input, a power output on the on-board power supply side, a fuse holder which accommodates a fuse protecting the power output, and a switching contact arranged between the power input and the power output. An operating element is provided for actuating the switching contact, a locking element interacting with the operating element, a first securing element assuming two possible end positions, and a second securing element assuming two possible end positions. The first securing element is configured to lock the locking element against movement into a position that releases the operating element when the switching contact is closed, and wherein the second securing element is configured to cause the locking element to be moved into a position that locks the operating element when the switching contact is open.

### CROSS-REFERENCE TO RELATED APPLICATIONS

This application claims the benefit of European Application No. 251770459, filed on May 16, 2025. The entire disclosure of the application referenced above is incorporated herein by reference.

### FIELD

The disclosure relates to a switching device for a train for arrangement in a current path between a train’s own battery module and an on-board power supply of the train. Furthermore, the disclosure relates to a method for electrically disconnecting a current path between a battery module and an on-board power supply of a train by means of a switching device arranged in the current path.

### BACKGROUND

Switching devices of the type mentioned above in general and those for trains in particular are well known from the prior art, which is why no separate written evidence is required at this point.

According to the prior art, a train’s own battery module is provided to supply power to the on-board power supply of the train. The battery module and the on-board power supply are electrically operatively connected via a current path.

The battery module is typically designed as a lithium-ion battery module and has a plurality of lithium-ion cells that are electrically interconnected. The on-board power supply of the train also comprises a plurality of individual components, typically a battery management system and at least one consumer. Together, the battery module and the on-board power supply electrically operatively connected to it form an on-board voltage system.

According to the prior art, a train typically has two on-board voltage systems. A first voltage system is used in particular to supply train-side computer systems and/or a train control system. A second voltage system supplies all other systems of the train and enables the train to move even without an external power supply, for example on non-electrified lines or in an emergency.

According to the prior art, two separate battery modules are provided for voltage supply of the two on-board voltage systems, i.e., a first battery module for the first on-board voltage system and a second battery module for the second on-board voltage system.

A switching device is arranged in the current path between a battery module and the associated on-board power supply of the train. This switching device serves to disconnect the electrical operative connection between the battery module and the associated on-board power supply if necessary. According to the prior art, disconnectors are typically used as such switching devices.

Known disconnectors are used in particular to electrically disconnect the battery module from the associated on-board power supply, which allows a user to safely perform maintenance work, whether on the battery module or on the battery management system. Furthermore, when the current path between the battery module and the on-board power supply is disconnected, it is safe to change the fuse.

Although known disconnectors have proven themselves in everyday practical use, there is room for improvement. In particular, it is desirable to be able to reliably prevent the unintentional switching of a disconnector. In view of the above, it is an object of the disclosure to further develop a switching device in terms of construction in such a way that safe handling is guaranteed while at the same time ensuring ease of operation.

### SUMMARY

To achieve this object, there is proposed on the device side a switching device for a train for arrangement in a current path between a train's own battery module and an on-board power supply of the train, comprising a power input on the battery module side, a power output on the on-board power supply side, a fuse holder that accommodates a fuse to protect the power output and a switching contact arranged between the power input and the power output, as well as an operating element provided for actuating the switching contact, a locking element interacting with the operating element, a first securing element assuming two possible end positions and a second securing element assuming two possible end positions, wherein the first securing element is configured to lock the locking element against being moved into a position that releases the operating element when the switching contact is closed and wherein the second securing element is configured to cause the locking element to be moved into a position that locks the operating element when the switching contact is open.

Furthermore, to achieve the above object, a method for electrically disconnecting a current path between a battery module and an on-board power supply of a train by means of a switching device arranged in the current path is proposed, in which a first securing element is actuated and a locking element interacting with it is moved into a position in which an operating element operatively connected to a switching contact of the switching device is released, in which the operating element is actuated and the switching contact is moved into an open position to electrically disconnect the current path, and in which a second securing element and a locking element interacting therewith are moved into a position in which, when the switching contact is open, a return movement of the operating element is locked.

The switching device according to the disclosure has a power input on the battery module side on the one hand and a power output on the on-board power supply side on the other. In the final assembled state, the switching device is arranged in the current path between the battery module and the on-board power supply, wherein the battery module is electrically coupled to the switching device via the power input provided for this purpose, and the on-board power supply is electrically connected to the power output of the switching device. The on-board power supply may preferably be the traction network of the train, in which case the battery module operatively connected thereto is a high-voltage battery module suitable for traction.

The switching device also has a fuse holder which serves to accommodate at least one fuse. This fuse serves to protect the power output. In the intended use case, a plurality of fuses are arranged in the fuse holder of the switching device.

The switching device also includes a switching contact. This is arranged between the power input and the power output. This switching contact can be either open or closed. If the switching contact is in the open state, the current path is electrically disconnected, whereas the current path is not electrically interrupted if the switching contact is in the closed state. Since the switching contact is electrically arranged between the power input and the power output, the current path can be opened or closed by means of the switching device, depending on the position of the switching contact. Voltage supply of the on-board power supply by the battery module connected to it electrically is only possible when the switching contact is closed, with the switching device arranged in between.

The switching device also has an operating element for actuating the switching contact. This operating element can be actuated manually by a user, allowing the user to switch the switching contact as desired, i.e., to move it from the open position to the closed position or vice versa.

The switching device also has two securing elements, a first securing element and a second securing element. Both securing elements can be moved into two possible end positions, respectively. In each case, it is permitted for a user to move a securing element from one possible end position to the other possible end position and vice versa.

According to the disclosure, the first securing element is configured to lock the locking element against movement into a position that releases the operating element when the switching contact is closed. In a first position of the locking element, the operating element cannot be actuated by a user. It is positionally secured by the locking element so that it cannot be moved freely. In a first end position, the securing element serves to lock the locking element in this position, which does not release the operating element, i.e., without first actuating the associated securing element, the locking element cannot be moved to release the operating element. This position of the locking element and securing element is given when the switching contact is closed. This position is typically the so-called normal position in which the current path is closed, i.e., the on-board power supply of the train is supplied with voltage from the battery module electrically connected to it. In this normal position, it is not possible to disconnect the current path by manually actuating the operating element interacting with the switching contact because the operating element is locked by the locking element. However, it is not readily possible to release the operating element by actuating the locking element, as the locking element is locked by the securing element. It is therefore necessary to first actuate the securing element so that the locking element can then be actuated, which leads to the release of the operating element. Disconnection of the electrical operative connection between the battery module and the on-board power supply by actuation of the switching contact interacting with the operating element by a user manually actuating the operating element is possible only after the operating element has been released.

This constructive design ensures that there can be no unintentional disconnection of the electrical connection between the battery module and the on-board power supply. At the same time, it provides for easy operation, where the user only has to ensure that the correct operating sequence of the securing element, locking element, and operating element is observed. This also prevents incorrect operation, which also contributes to overall safe handling.

According to the disclosure it is also provided for the second securing element being configured to move the locking element into a position that locks the operating element when the switching contact is open.

If the switching contact is open due to previous actuation of the operating element, the on-board power supply is de-energized because the current path between the battery module and the on-board power supply is electrically interrupted. In this position of the switching contact, a user can safely carry out maintenance work, in particular on the battery management system, replace fuses housed in the fuse holder of the switching device and/or carry out other repair work on the battery module and/or on-board power supply. To ensure that the operating element is not actuated unintentionally, resulting in the switching contact being moved from the open position to the closed position, the locking element must be moved to a position that locks the operating element. In this locking position, the operating element cannot be returned to its position closing the switching contact because it is prevented from doing so by the locking element. However, the locking element can only be moved to this position locking the operating element if the second securing element has been actuated beforehand. Only when this has first been moved from its first to its second end position is it possible to move the locking element to another position. Once the operating element is locked against actuation by the locking element when the switching contact is open, the second securing element provides additional protection by ensuring that the operating element cannot be released by moving the locking element without first actuating the second securing element. This also ensures safe handling in an advantageous manner while at the same time allowing for easy operation. In particular, it is ensured that during maintenance or repair work and/or a fuse replacement, an unwanted electrical connection between the battery module and the on-board power supply cannot be established. Instead, the second securing element must first be actuated, followed by actuation of the locking element, before the operating element can be released and actuated to move the switching contact into the closed position.

The switching device according to the disclosure advantageously combines a fuse holder for holding fuses and a switching contact in a single device. This enables pre-configuration, so that all that is required at the installation site is to make an electrical connection to the current path by means of the power input provided on the device side on the one hand and the power output on the other. Furthermore, the switching device according to the disclosure provides a security concept in terms of design that basically prevents incorrect operation or at least unintentional incorrect operation. The constructive implementation of the safety concept is an integral part of the switching device according to the disclosure which enables simple assembly and disassembly and at the same time ensures safe handling during normal operation.

On the method side, in order to electrically disconnect a current path between a battery module and an on-board power supply of a train by means of a switching device arranged in the current path, it is provided that a first securing element is first actuated. A locking element interacting with it can then be moved into a position in which an operating element operationally connected to a switching contact of the switching device is released. Accordingly, only when the first securing element has been moved into the position provided for this purpose can the locking element be actuated, with the result that the operating element is released. Only when the operating element is released, actuation thereof by a user is possible, which then leads to actuation of the switching contact of the switching device interacting with it.

When the switching contact is open, i.e., when an operating element has been previously actuated as intended, a second securing element must then be actuated in a final step of the method so that a locking element interacting with it is moved into a position in which the operating element is locked against returning to its original position, i.e., the operating element cannot be unintentionally returned to its initial position, resulting in the switching contact being actuated. The actuation of the second securing element therefore serves to lock the operating element in the open position of the switching contact by means of the locking element provided for this purpose, so that it is not possible to move the switching contact into the closed position by means of the operating element.

The method described above according to the disclosure provides the advantages already explained on the basis of the switching device according to the disclosure. In particular, simplified operation is provided while ensuring safe handling.

According to a further feature of the disclosure, the switching device is provided with a housing comprising a base body and a cover detachably arranged thereon by means of appropriate fastening means. The housing of the switching device accommodates the aforementioned components of the switching device. A construction unit is thus created that is easy to handle and therefore also easy to assemble and disassemble. The housing provides a base body on the one hand and a cover on the other. The base body has a corresponding volume space for accommodating the components of the switching device according to the disclosure. The base body has an open side for equipping the volume space. When fully assembled, this open side is closed by a cover that is detachably arranged on the base body. Appropriate fastening means, which may be screws, for example, are used to detachably arrange the cover on the base body.

To access the volume space provided by the base body, the cover of the base body must be removed. To this end, the fasteners provided for this purpose must first be removed. It is particularly preferable that the fuse holder, together with the fuses it holds, is covered by the cover. When the cover is removed, the user can therefore access the fuse holder and the fuses it houses. This allows for easy fuse replacement, as the cover only needs to be removed from the base body, the fuse replaced, and the cover then reattached to the base body.

According to a further feature of the disclosure it is provided that the free accessibility of the fastening means is locked by the operating element when the switching contact is closed. This provides an additional safety measure. Because as long as the operating element is still in the so-called normal position, in which the switching contact is closed, it is not possible to access the fastening means through the operating element itself. The design thus ensures that the fastening means provided for attaching the cover to the base body cannot be reached when the operating element is in the normal position. In particular, fuse replacement is therefore safely impossible when the operating element is in the normal position.

According to a further feature of the disclosure, it is proposed in this context that the fastening means are concealed by the operating element when the switching contact is closed. The locking of free access to the fastening means by the operating element is preferably achieved by the operating element concealing the fastening elements when the switching contact is closed. Accessibility to the fastening means is therefore locked by the fact that the operating element itself prevents access to the fastening means. This ensures increased operational safety with a simple design.

According to a further feature of the disclosure it is provided that the operating element is a lever that is pivotably arranged on the base body of the housing. In the intended use, this lever can be easily grasped by a user and moved from a first position to a second position and vice versa. The first position is, for example, the normal position in which the switching contact is closed. In the second position, the lever is in the disconnect position in which the switching contact is open, so that the electrical connection between the battery module and the on-board power supply is disconnected.

According to a further feature of the disclosure it is provided that the lever has a first pivot arm, a second pivot arm, and a lever handle arranged between the two pivot arms. This design gives the lever a robust construction. In particular, two pivot arms are provided, which enable precise and double-guided movement of the lever handle coupled to the pivot arms. The lever handle extends like a rod between the two pivot arms, which ensures that the fastening means connecting the cover to the base body in a detachable manner is securely covered when the lever is in its normal position.

According to a further feature of the disclosure, the operating element interacts with the switching contact via an intermediate gear. The operating element in operative connection with the switching contact therefore does not act directly on the switching contact, but indirectly via an intermediate gear. This enables a targeted introduction of force into the switching contact for the purpose of switching it, while at the same time ensuring a compact overall design of the switching device according to the disclosure.

According to a further feature of the disclosure it is provided in this context that the gear has a force transmission means on the operating element side and a counterpart interacting with it, wherein the counterpart is movably accommodated by the housing and carries a switching contact component of the switching contact.

The switching contact provided according to the disclosure has two switching contact components. If these are in electrical operative connection, the switching contact is closed. Otherwise, the switching contact is open.

One of the two switching contact components is carried by a counterpart that is operatively connected to a force transmission means. Thus, when the counterpart is moved under the force of the force transmission means, this results in a relative displacement movement of the two switching contact components to each other, with the result that the switching contact is opened. The counterpart can preferably be spring-loaded and therefore tend to return to the normal position in which the two switching contact components are electrically connected and the switching contact is therefore closed.

The force transmission means is formed on the operating element side. It therefore moves as a result of a force being applied to the operating element by a user. The force thus provided is transmitted by means of the force transmission means to the counterpart, which then moves, resulting in a separation of the two switching contact components. The result is a robust yet precise switching arrangement.

According to a further feature of the disclosure it is provided in this context that the counterpart is movably received by a gate. The counterpart moves as a result of a force being applied to it, whereby the movement of the counterpart is guided by means of a gate. In the intended use, the counterpart therefore describes a predetermined movement path based on the guidance predefined by the gate. This also supports a precise and robust switching contact design.

According to a further feature of the disclosure it is provided that the locking element is designed in two parts and has a first movable locking slider and a second movable locking slider. The two locking sliders serve to enable or disable operation of the operating element, depending on their position. The two locking sliders can be operated independently of each other, so that when the switching contact is closed, the operating element can either be released or locked in its movement by means of one locking slider, and when the switching contact is open, it can also be locked in its position or released for movement by means of the other locking slider.

According to a further feature of the disclosure it is provided that the first locking slider interacts with the first securing element and the first pivot arm, and the second locking slider interacts with the second securing element and the second pivot arm.

The first locking slider interacts with the first pivot arm of the lever. Depending on the position of the locking slider, the pivot arm is either locked or not in its movement, and thus also the lever serving as the operating element as such. Whether a movement of the locking slider is possible depends on the position of the first securing element. If the locking slider is released by means of the locking element, the locking slider can be moved accordingly and release the operating element or not. Otherwise, the locking slider is locked by means of the first securing element, so that the locking slider cannot move freely. This correspondingly applies to the second locking slider, which interacts with the second securing element and the second pivot arm.

According to a further feature of the disclosure it is provided that the securing elements are key-operated locking cylinders. Actuating a securing element therefore requires the user to have the correct key to operate the locking cylinder. This also provides an additional security measure, as unauthorized persons cannot actuate a securing element.

According to a further feature of the disclosure it is provided that the first locking slider, the first pivot arm, or the first securing element is designed to interact with a sensor, preferably a microswitch. The sensor makes it possible, in an advantageous way, to detect in particular the position of the locking slider that interacts with the first pivot arm and the first securing element. Alternatively, the first pivot arm or the first securing element can also be detected by a sensor. The sensor detection of the first locking slider allows a corresponding display to be provided to a user and/or switching of the second locking slider to be enabled only when the required position of the first locking slider has been detected by the sensor. This advantageously provides an additional increase in operational safety.

According to a further feature of the disclosure, a temperature sensor is provided, which is preferably installed in the housing and placed in close proximity to the switching contact. If a temperature above a predetermined setpoint temperature is detected, the temperature sensor can automatically disconnect the current path or emit an alarm signal to alert the user to the need to disconnect the current path.

### BRIEF DESCRIPTION OF DRAWINGS

Further features and advantages of the disclosure are apparent from the following description with reference to the drawings wherein it is shown by:

FIG. 1 a purely schematic representation of the arrangement of a switching device according to the disclosure;

FIG. 2 a schematic perspective view of a switching device according to the disclosure;

FIG. 3 a top view of the switching device according to FIG. 2;

FIG. 4 a schematic perspective view of an operating element of the switching device according to the disclosure in a first position;

FIG. 5 a schematic perspective view of the operating element according to FIG. 4 in a second position;

FIG. 6 a schematic top view of the operating element of the switching device according to the disclosure in a first position;

FIG. 7 the operating element according to FIG. 6 in a second position, and

FIG. 8 a schematic flow diagram of the method according to the disclosure.

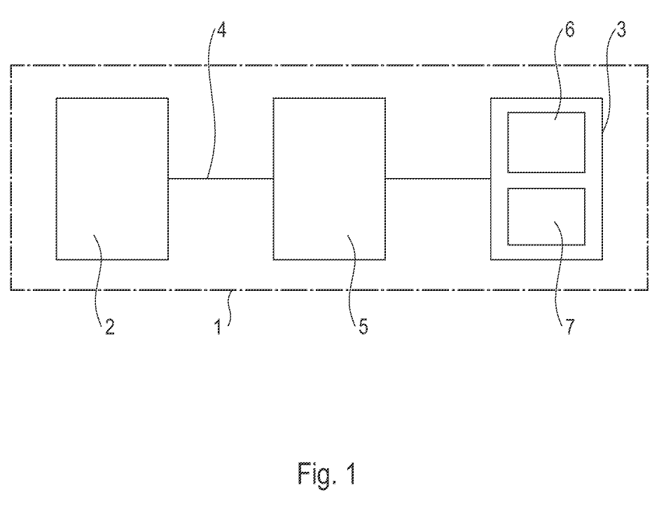

FIG. 1 shows a schematic representation of the arrangement of a switching device 5 according to the disclosure in a current path 4 of a train

### DETAILED DESCRIPTION

As can be seen from the illustration in FIG. 1, a train 1, which is shown only schematically, has a battery module 2 on the one hand and an on-board power supply 3 on the other. In the embodiment shown, the on-board power supply 3 comprises a battery management system 6 and a consumer 7. Alternatively, the battery management system 6 may be designed separately from the on-board power supply 3. In particular, the battery management system 6 may be designed preferably as an integral part of the battery module 2, or the battery module 2 and the battery management system 6 may be combined into a single unit. The on-board power supply 3 may in particular be a traction network, i.e., an on-board power supply of a high-voltage system.

The train's own battery module 2 is electrically connected to the on-board power supply 3 of the train 1 via a current path 4. A switching device 5 according to the disclosure is integrated into the current path 4. The current path 4 can be interrupted by means of the switching device 5, i.e., the electrical connection between the battery module 2 and the on-board power supply 3 can be disconnected by means of the switching device 5 according to the disclosure.

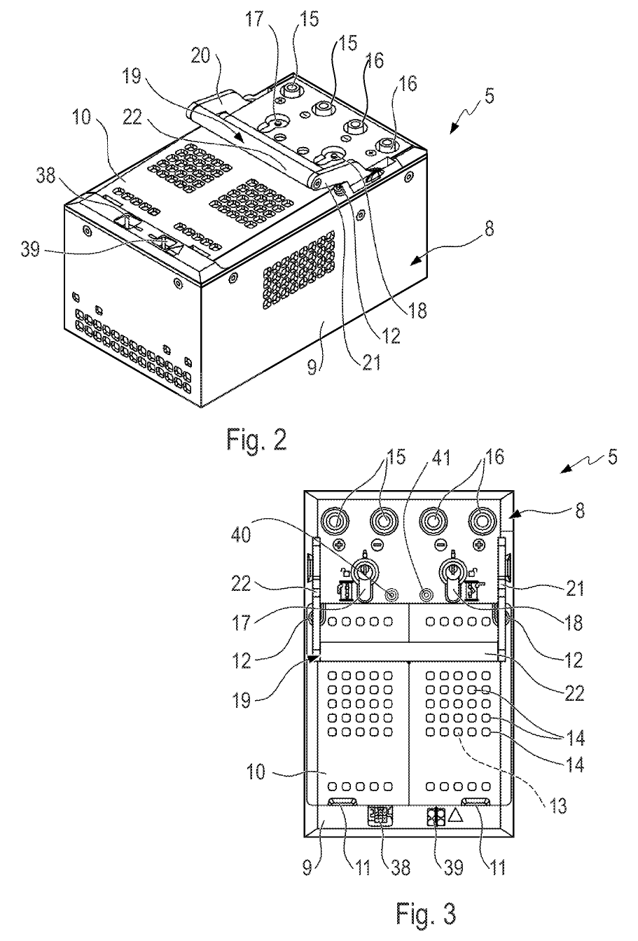

The design of the switching device 5 according to the disclosure can be seen from a combined view of the further FIGS. 2 to 7.

As can be seen from FIGS. 2 and 3, the switching device 5 has a housing 8. This housing 8 has a base body 9 and a cover 10. The cover 10 is detachably arranged on the base body 9, for which purpose screws 12 serving as fastening means are used, among other things.

The housing 8 of the switching device 5 also provides a power input 15 and a power output 16. When used as intended, the battery module 2 is connected to the power input 15 and the on-board power supply 3 is connected to the power output 16.

The switching device 5 also has a fuse holder 13 which, when finally assembled, is accommodated by the housing 8 and which accommodates a fuse protecting the power output 16. The user can access the fuses housed in the fuse holder 13 after removing the cover 10 from the base body 9. To do this, the screws 12 must first be removed. The cover 10 can then be pivoted relative to the base body 9 about a pivot axis defined by the extensions 11 of the cover, allowing the extensions 11 to be released from the corresponding openings in the base body 9. When the cover 10 is removed, fuses can be changed or replaced, which in the embodiment shown, in particular in FIG. 3, are only schematically visible through the openings 14 provided by the cover 10.

After replacing fuses and/or performing maintenance, the housing 8 can be closed by replacing the cover 10, proceeding in reverse order, i.e., first inserting the extensions 11 of the cover 10 into the corresponding openings of the base body, then pivoting the cover 10 toward the base body 9, and finally inserting and tightening the screws 12.

The switching device 5 also has securing elements, namely a first securing element 17 and a second securing element 18. In the embodiment shown, the securing elements 17 and 18 are each designed as locking cylinders, which means that the securing elements 17 and 18 are operated by a key.

The switching device 5 provides a switching contact 23 housed in the housing 8, as will be described in more detail below. The switching contact 23 is actuated by the user by means of an operating element 19, which in the embodiment shown is a lever.

The top view in FIG. 3 also shows two measuring sockets 40 and 41, which are arranged between the two fuse elements 17 and 18. The measuring sockets 40 and 41 are used for the optional connection of a voltage tester. A standard voltage tester can be used for this purpose. In the intended use case, a voltage tester connected to the switching device 5 serves in particular to detect the absence of voltage in the case of an open switching contact 23. When the switching contact 23 is closed, the voltage tester can detect the voltage applied as intended. Alternatively, instead of the two measuring sockets 40 and 41, a voltage tester can also be integrated into the switching device 5. In this case, the housing 8 provides a corresponding voltage display.

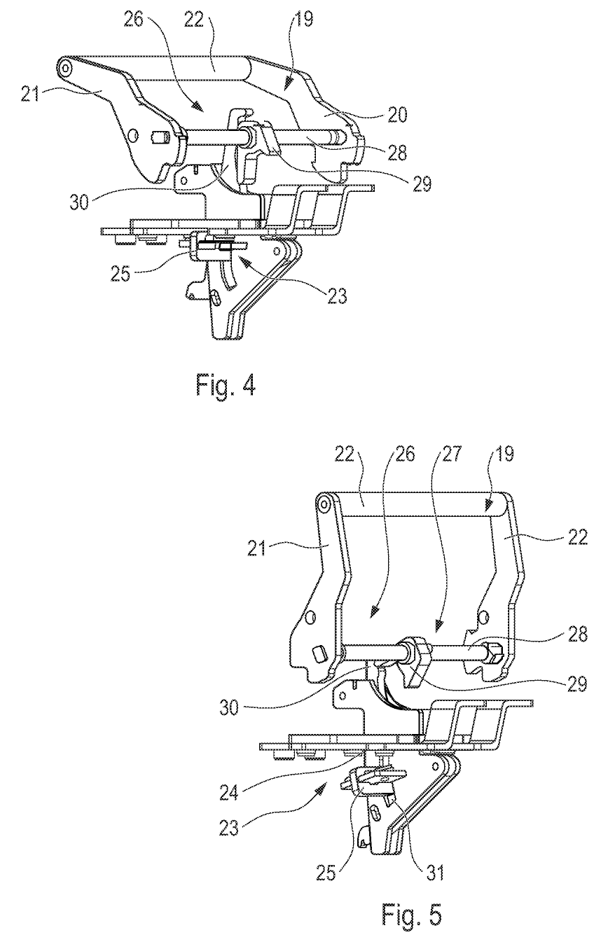

As can be seen in particular from a combined view of FIGS. 4 and 5, the lever 19 is pivotably arranged on the base body 9 of the housing 8 and has a first pivot arm 20 and a second pivot arm 21. A lever handle 22 in the form of a rod is arranged between the two pivot arms 20 and 21. This lever handle is gripped by a user during normal use, which then enables a relative pivoting movement of the lever 19 in relation to the housing 8.

As FIGS. 4 and 5 further show, the lever 19 also has a rod 28 connecting the two swivel arms 20 and 21, which rod is formed opposite the lever handle 22. In normal use, the lever 19 pivots about an axis of rotation defined by the rod 28.

The lever 19 interacts with the switching contact 23 provided by the switching device 5. A gear 26 is provided for this purpose, as can be seen in particular from the combined view of FIGS. 4 and 5.

The gear 26 has a lever-side force transmission means 27. This is provided by the rod 28 and a cam element 29 carried by the rod 28. The gear 26 also has a counterpart 30 on the switching contact side, which interacts with the cam element 29. In the intended use case, a pivoting movement of the lever 19 from the position shown in FIG. 4 to the position shown in FIG. 5 causes the cam element 29 to rotate about the axis of rotation provided by the rod 28, as a result of which the counterpart 30 interacting with the cam element 29 moves within a gate 31.

The switching contact 23 has the two switching contact components 24 and 25. The switching contact component 25 is carried by the counterpart 30. If, during normal use, the lever 19 pivots to the position shown in FIG. 5, the switching contact component 25 moves together with the counterpart 30, causing the two switching contact components 24 and 25 to separate from each other. In the position shown in FIG. 5, the switching contact 23 is therefore open, whereas the switching contact 23 is closed in the position shown in FIG. 4.

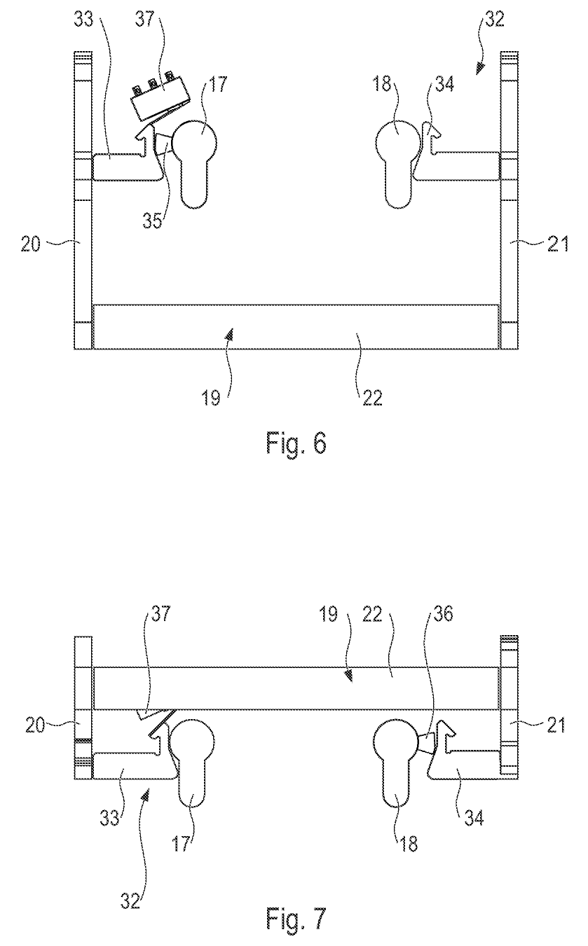

A rotational movement of the lever 19 can be locked by means of the locking element 32 provided by the switching device 5. As can be seen in this context from a combined view of FIGS. 6 and 7, the locking element 32 is designed in two parts and has a first locking slider 33 and a second locking slider 34. Both sliders 33 and 34 can be moved translationally into a locking position and into a release position, respectively. The first locking slider 33 interacts with the first pivot arm 20 of the lever 19 and the second locking slider 34 interacts with the second pivot arm 21 of the lever 19.

FIG. 6 shows the lever 19 with the switching contact 23 closed, i.e., in a position as shown in FIGS. 2, 3, and 4. In this position of the lever 19, the first locking slider 33 can be moved from a position locking the lever 19 to a position releasing the lever 19. FIG. 6 shows a position of the locking slider 33 that locks the lever 19. It is not possible to move the second locking slider 34 in this position of the lever 19.

FIG. 7 shows the lever 19 with the switching contact 23 open, i.e., in a position that can also be seen in FIG. 5. In this position, the lever 19 is pivoted to the right from the position shown in FIG. 4 with reference to the drawing plane shown in FIG. 4, i.e., upward with reference to the drawing plane shown in FIG. 2. In this position of lever 19, the second locking slider 34 can be moved from a position releasing lever 19 to a position locking lever 19 and vice versa. FIG. 7 shows the second locking slider 34 in a position in which lever 19 is locked in its pivoting movement. The first locking slider 33 cannot be moved in this position of the lever 19.

In the embodiment shown in FIGS. 6 and 7, the first locking slider 33 interacts with a sensor 37 in the form of a microswitch. In the position of the first locking slider 33 locking the lever 19, the microswitch 37 is closed. As soon as the locking slider is moved to the position shown in FIG. 7, the microswitch 37 opens and delivers a corresponding signal.

FIGS. 6 and 7 also show the securing elements 17 and 18, each designed as a locking cylinder. Each securing element 17 and 18 has a bolt element 35 and 36, respectively, which, depending on the key position of a key interacting with the respective securing element, locks or releases the associated locking slider 33 or 34 in its movement. FIG. 6 shows a position of the first securing element 17, according to which a displacement of the first locking slider 33 from the position shown in FIG. 6 to the position shown in FIG. 7 is prevented by the bolt element 35 locking the first locking slider 33.

The same can be seen in the Figures with reference to the second securing element 18. FIG. 7 shows a position of the second locking slider 34 in which the lever 19 is locked in its movement when the switching contact 23 is open. The second locking element 34 is also locked in its movement because it is locked by the bolt element 36 of the second securing element 18. Only when the securing element 18 is actuated and the bolt element 36 is disengaged from the locking slider 34 can the locking slider 34 be moved from the position shown in FIG. 7 to the position shown in FIG. 6, in which the lever 19 is then also released.

The switching device 5 described above allows operation as follows.

FIGS. 2 to 4 and 6 show the switching device 5 in its normal position. In this normal position, the lever 19 is closed and locked and the switching contact 23 is closed. The switching device 5 can therefore conduct current from the battery module 2 to the on-board power supply 3.

If maintenance work, repair work, or fuse replacement is to be carried out on the switching device 5, the current flow to the on-board power supply 3 must be disconnected. For this purpose, the switching contact 23 must be switched by actuating the lever 19.

In order to be able to actuate the lever 19, the locking slider 33 must be moved to a position that releases the lever 19. For this purpose, the user must insert the appropriate key into the securing element 17 and turn it 90° so that the corresponding bolt element 35 of the first securing element 17 disengages from the first locking slider 33. Once this has been done, the locking slider 33 can be moved to release the lever 19. At the same time, the microswitch 37 opens and sends a signal to the on-board power supply 3 to indicate that the lever 19 is unlocked. The user can now open the lever 19 and move it to the end position shown in FIGS. 5 and 7. As a result, the switching contact 23 is opened, thereby disconnecting the current path 4 between the battery module 2 and the on-board power supply 3. The mechanical separation of the two switching contact components 24 and 25 of the switching contact 23 can be detected by a sensor, so that a signal can be sent to the on-board power supply 3 to indicate that the switching contact 23 is open.

In a further step, the user now actuates the second securing element 18. According to the embodiment shown, a locking cylinder 18 is used for this purpose, which interacts with the second locking slider 34 with its bolt element 36. In the locked position, the second locking slider 34 engages with the lever 19 so that the lever 19 cannot be pivoted in this position of the locking slider 34. This reliably prevents the lever 19 from pivoting back to its initial position as shown for example in FIG. 2. Due to the position of the second securing element 18, it is not possible to move the second locking slider 34 in the position shown in FIG. 7, which means that the lever 19 is reliably secured in its position.

In the position of the second locking element 18 shown in FIG. 7, it is preferably not possible to turn or remove the key inserted in the locking cylinder 17, as it is locked in this position. It is also not possible to turn and remove the second locking element 18 when the lever is closed, as the lever is locked in the lever position.

As can also be seen in particular from a combined view of FIGS. 2 and 3, the screws 12 for the cover 10 are not accessible when the lever 19 is in its normal position. Removing the cover 10 to access the fuse holder 13 is therefore only possible when the lever 19 is moved to its open position as shown in FIG. 5, in which position the current path 4 is disconnected.

As can also be seen from a combined view of FIGS. 2 and 3, the switching device 5 can also have a connection 38 for connecting a data line. Furthermore, a connection 39 may be provided for connecting an auxiliary power path, for example an auxiliary path for supplying auxiliary power to one of two voltage networks of the on-board power supply 3. The outputs provided for this purpose are preferably additionally protected by fuses provided by the fuse holder 13.

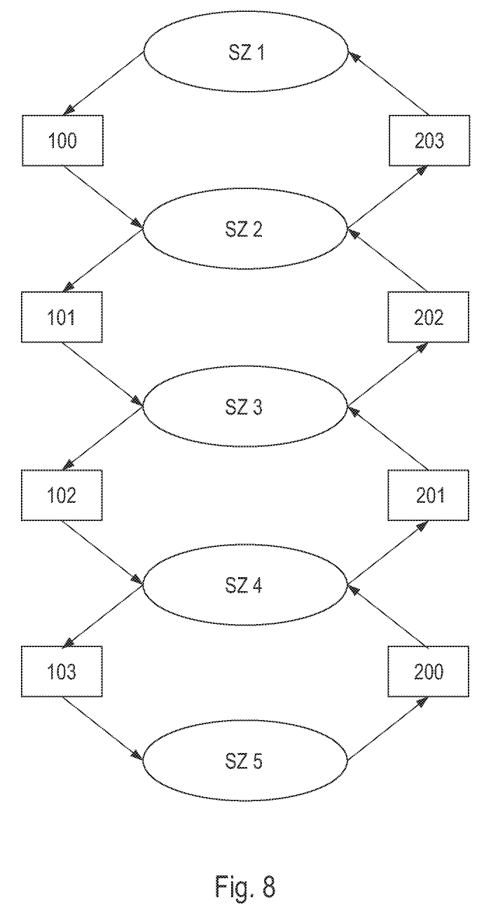

FIG. 8 shows an example of a process flow according to the disclosure in a purely schematic representation. Switching state SZ 1 is the starting point. According to this switching state, switching contact 23 is closed and battery module 2 is electrically operatively connected to the on-board power supply 3 via current path 4. To disconnect the current path 4, the first fuse element 17 must first be operated in accordance with process step 100, for which purpose the corresponding key is inserted into the locking cylinder 17 and turned. The first locking slider 33 is now released and moved so that a corresponding signal is communicated by means of the microswitch 37. The switching state SZ 2 is therefore present.

In accordance with method step 101, the lever 19 is now pivoted on the operator side. The switching state SZ 3 is then present, in which the switching contact 23 is open. The lever 19 is not yet secured in this position.

The lever 19 is secured in accordance with method step 102 by actuating the second securing element 18. This results in switching state SZ 4, in which the switching contact is secured in the open position. “Secured” means in this case that the lever 19 cannot pivot back unintentionally in the manner described above.

According to method step 103, the screws 12 accessible when lever 19 is pivoted can now be reached and removed by the user, so that a fuse replacement can then take place according to switching state SZ 5 after removal of cover 10.

To return from switching state SZ 5 to the normal state according to switching state SZ 1, the procedure described above must be carried out in reverse order according to methods steps 200 to 203.

1. A switching device for a train for arrangement in a current path between a train's own battery module and an on-board power supply of the train comprising a power input on the battery module side, a power output on the on-board power supply side, a fuse holder which accommodates a fuse protecting the power output , and a switching contact arranged between the power input and the power output , and further comprising an operating element provided for actuating the switching contact, a locking element interacting with the operating element, a first securing element which can assuming two possible end positions, and a second securing element assuming two possible end positions, wherein the first securing element is configured to lock the movement of the locking element into a position that releases the operating element when the switching contact is closed, and wherein the second securing element is configured to cause the locking element to be moved into a position that locks the operating element when the switching contact is open.

2. The switching device according to claim 1, wherein a housing comprising a base body and a cover detachably arranged thereon using corresponding fastening means.

3. The switching device according to claim 2, wherein the free accessibility of the fastening means is locked by the operating element when the switching contact is closed.

4. The switching device according to claim 3, wherein the fastening elements are covered by the operating element when the switching contact is closed.

5. The switching device according to claim 2, wherein the fuse holder is covered by the cover.

6. The switching device according to claim 2, wherein the operating element is a lever pivotably arranged on the base body of the housing.

7. The switching device according to claim 6, wherein the lever has a first pivot arm, a second pivot arm and a lever handle arranged between the two pivot arms.

8. The switching device according to claim 1, wherein the operating element interacts with the switching contact via an intermediate gear.

9. The switching device according to claim 8, wherein the gear has a force transmission means on the operating element side and a counterpart interacting therewith, wherein the counterpart is movably received in the housing and carries a switching contact component of the switching contact.

10. The switching device according to claim 9, wherein the counterpart is movably received by a gate.

11. The switching device according to claim 1, wherein the locking element is designed in two parts and has a first movable locking slider and a second movable locking slider .

12. The switching device according to claim 11, wherein the first locking slider interacts with the first securing element and the first pivot arm and the second locking slider interacts with the second securing element and the second pivot arm.

13. The switching device according to claim 1, wherein the locking elements are key-operated locking cylinders.

14. The switching device according to claim 11, wherein the first locking slider, the first pivot armor the first securing element interact with a sensor, preferably a microswitch.

15. A method for electrically disconnecting a current path between a battery module and an on-board power supply of a train by means of a switching device arranged in the current path,
in which a first securing element is actuated and a locking element interacting with it is moved into a position in which an operating element operatively connected to a switching contact of the switching device is released,
in which the operating element is actuated and the switching contact is moved into an open position to electrically disconnect the current path, and
in which a second securing element and a locking element interacting therewith are moved into a position in which the operating element is locked against returning when the switching contact is open.
